(19) United States
(12) Patent Application Publication
(10) Pub. No.: US 2011/0085108 A1
(43) Pub. Date: Apr. 14, 2011

(54) OPTICAL DEVICE, AND BACKLIGHT UNIT AND LIQUID CRYSTAL DISPLAY INCLUDING THE SAME

(75) Inventors: Jeong-Ho Park, Seoul (KR); Young-Soo Do, Seoul (KR); Do-Yun Kim, Suwon-Gyeonggi-do (KR); Jung-Ae An, Seoul (KR)

(73) Assignee: LMS CO., LTD, Gyeonggi-do (KR)

(21) Appl. No.: 12/996,933

(22) PCT Filed: Jun. 9, 2009
(86) PCT No.: PCT/KR2009/003088

§ 371 Date: Dec. 8, 2010

(30) Foreign Application Priority Data
Jun. 9, 2008 (KR) 10-2008-0053508

(51) Int. Cl. G02F 1/1335; G02B 5/02; G02F 1/13357

(52) U.S. Cl. 349/61; 359/599; 362/97.1

(57) ABSTRACT

An optical device which maintains luminance characteristics to the greatest extent, improves light-collecting effects, and realizes a wide viewing angle, and a backlight unit and an LCD including the same. The optical device includes a light-transmitting base film. A plurality of convex portions is formed on at least one surface of the base film, and microscopic optical patterns have peaks and valleys, which abut each other, on part of the convex portions. Alternatively, a plurality of third fine optical patterns is formed on at least one surface of the base film. A portion of each third fine optical patterns abutting the base film forms a figure having long and short axes. Each of the third fine optical patterns has a peak with a height that decreases from the center to both ends thereof along the long axis.

### TECHNICAL FIELD

The present invention relates to an optical device used in a Liquid Crystal Display (LCD), and more particularly, to an optical device that increases a light-condensing effect and realizes a wide viewing angle while maintaining high-luminance characteristics to the greatest extent in an LCD, and a backlight unit and an LCD including the same.

### BACKGROUND ART

In general, optical devices, which are widely used in a Liquid Crystal Display (LCD), include a light guide plate, a diffuser plate, a prism sheet, a liquid crystal panel, etc. Such optical devices are generally used in the LCD for the purpose of light diffusion, light condensation, luminance improvement, etc. For example, light that is incident from a light source is converted into surface light through the light guide plate, is diffused by the diffuser plate, and enters the prism sheet from below. Here, the prism sheet can improve the luminance of the LCD by condensing incident light onto a light exit surface.

FIG. 1 is a schematic cross-sectional view showing a general LCD.

As shown in FIG. 1, the LCD 10 generally includes a backlight unit A and a panel unit B. The backlight unit A includes a light guide plate 12, a diffuser plate 13, at least one prism sheet 14, a reflective polarizer film 15, and a phase retardation layer 16. The light guide plate 12 and the diffuser plate 13 diffuse and emit light that is incident from a light source 10. The prism sheet 14 condenses and emits the light that is incident from the diffuser plate 13. The reflective polarizer film 15 selectively reflects the light that is incident from the prism sheet 14. The phase retardation layer 16 converts circularly-polarized light that has passed through the reflective polarizer film 15 into linearly-polarized light. The panel unit B includes an absorptive polarizer film 17 and a liquid crystal panel 18. The absorptive polarizer film 17 allows the linearly-polarized light, which is emitted from the backlight unit A, to pass through, and allows 50% of the circularly-polarized light, which is emitted from the backlight unit A, to pass through while absorbing the remaining portion of the circularly-polarized light. The liquid crystal panel 18 visually displays a screen. Reference numeral 11, which has not been described, indicates a reflecting plate.

In the case of various types of optical devices such an LCD, technical development has been focused on the improvement of a light-condensing function in order to realize high luminance. This is because the LCD is mainly used in personal electronics, such as mobile devices and notebook computers. Therefore, in the case of the personal electronics, viewing angle has not been regarded as a big problem. However, recently, LCD TVs have increased in size and have become popular due to decreased prices, so that a number of viewers can watch an LCD TV at the same time. In particular, a navigation device in a motorcar is required to have a wide viewing angle so that a screen can be watched from both the driver's seat and the seat next to the driver's seat.

Accordingly, in the related art, for the optical device having a wide viewing angle, a method of stacking a plurality of diffuser sheets on one another and a method of using a reflective polarizer film are used. The former method of using a plurality of diffuser sheets is limited in its ability to increase luminance and has a drawback in that the thickness of the product is increased because multiple diffuser sheets are stacked on one another. The latter method of using a reflective polarizer film has a disadvantage in that the high price decreases the competitiveness of a product, since the reflective polarizer film has enjoyed a monopoly in the market to date.

Accordingly, in the corresponding technical field, there still remains a demand for the technical development of an optical device that ensures that the LCD has a wide viewing angle.

### DISCLOSURE

### Technical Problem

The present invention has been made to solve the foregoing problems with the prior art, and an object of the invention is to provide an optical device that ensures that a Liquid Crystal Display (LCD) is slim and has an increased light-condensing effect and a wide viewing angle at a low cost while maintaining high-luminance characteristics to the greatest extent possible.

Another object of the invention is to provide a backlight unit and an LCD including the optical device.

### Technical Solution

In an embodiment of the invention for realizing the foregoing objects, the optical device includes a light-transmitting base film; a plurality of convex portions formed on at least one surface of the base film to diffuse incident light; and first microscopic optical patterns. Each of the first microscopic optical patterns is formed on a corresponding one of the convex portions to condense and emit incident light.

Here, the first microscopic optical pattern may have peaks and valleys, which are formed on at least part of the convex portion while abutting each other.

In an embodiment of the invention, the optical device may further include a second microscopic optical pattern, in which the second microscopic optical pattern is formed on the opposite surface of the base film to condense and/or diffuse incident light. The second microscopic pattern has peaks and valleys, which abut each other.

In an embodiment of the invention, each of the first and second microscopic patterns may have peaks and valleys, which are arranged to be parallel to each other.

In an embodiment of the invention, each of the first and second microscopic patterns may have peaks and valleys, which are arranged to intersect each other at predetermined angles.

In an embodiment of the invention, each of the convex portions may have a diameter ranging, preferably, from 50 to 100 μm.

In an embodiment of the invention, each of the convex portions may be a figure that has long and short axes, in which the long axis has a length ranging from 50 to 100 μm, and the short axis has a length ranging from 1 to 100 μm.

In an embodiment of the invention, each of the convex portions may have a height ranging from 10 to 40 μm.

In an embodiment of the invention, the convex portions may be spaced from each other at an interval ranging from 50 to 150 μm.

In an embodiment of the invention, at least some of the convex portions may have different heights.

In an embodiment of the invention, the first microscopic patterns may have a peak height ranging from 5 to 30 μm.

In an embodiment of the invention, the first microscopic patterns may have a peak width ranging from 10 to 30 μm.

In an embodiment of the invention, the first microscopic patterns may have different peak heights.

In an embodiment of the invention, each of the first microscopic patterns may be formed in the central portion of a corresponding one of the convex portions.

In an embodiment of the invention, part of the convex portions, on which the first microscopic patterns are not formed, may have a shape that is curved at a predetermine curvature.

In an embodiment of the invention for realizing the foregoing objects, the optical device includes a light-transmitting base film; and a plurality of third microscopic optical patterns formed on at least one surface of the base film to condense and emit incident light. Each of the third microscopic optical patterns abuts the base film at a portion thereof, which forms a figure that has long and short axes, in which each of the third microscopic optical patterns has a peak height that decreases from a central portion to both ends along the long axis.

Here, the third microscopic optical patterns may be formed on one surface of the base film. The optical device may further include fourth microscopic optical patterns formed on the opposite surface of the base film to condense and/or diffuse the incident light.

In an embodiment of the invention, the fourth microscopic optical patterns may have peaks and valleys, which abut each other.

In an embodiment of the invention, the third and fourth microscopic optical patterns may be arranged such that peaks and valleys thereof intersect at predetermined angles.

In an embodiment of the invention, the third microscopic optical patterns may have peaks, which are curved at a predetermined curvature along the long axis of the elliptical figure.

In an embodiment of the invention, the third microscopic optical patterns may have peaks, each of which has a central height that ranges from 0.2 to 200 μm

In an embodiment of the invention, in the figure that forms each of the third microscopic optical patterns, the long axis may have a length ranging from 1 to 5000 μm, and the short axis may have a length ranging from 1 to 100 μm.

In an embodiment of the invention, the third microscopic optical patterns may be spaced apart from each other at an interval ranging from 1 to 5000 μm.

In an embodiment of the invention, the third microscopic optical patterns may be arranged in the form of a matrix a matrix

In an embodiment of the invention, the third microscopic optical patterns may be arranged in a staggered configuration.

In addition, the invention provides a backlight unit that includes any of the optical devices, which are described in the foregoing embodiments, and an LCD including the backlight unit.

### ADVANTAGEOUS EFFECTS

According to the invention, it is possible to increase the light-condensing effect and realize a wide viewing angle in the LCD at a low cost.

In addition, the invention can improve luminance at oblique angles as well as that to the front, thereby maintaining uniform luminance across the screen of the LCD.

### DESCRIPTION OF DRAWINGS

FIG. 1 is a schematic cross-sectional view showing a general LCD.

FIG. 2 is a plan view showing an optical device according to a first exemplary embodiment of the invention.

FIG. 3 is a cross-sectional view taken along line A-A in FIG. 2.

FIG. 4 is an enlarged view of the key part in FIG. 3.

FIG. 5 is a cross-sectional view taken along line B-B in FIG. 2.

FIG. 6 is a cross-sectional view showing another embodiment of the first microscopic optical pattern of the invention.

FIG. 7 is an example view showing a variation of the optical device according to the first exemplary embodiment of the invention.

FIG. 8 is a perspective view showing an optical device according to a second exemplary embodiment of the invention.

FIG. 9 is a cross-sectional view taken along line C-C in FIG. 8.

FIGS. 10 to 12 are schematic views each showing a part of an LCD including an optical device according to an exemplary embodiment of the invention.

FIGS. 13 and 14 are schematic perspective views each showing an optical device according to a third exemplary embodiment of the invention.

FIG. 15 is a cross-sectional view and a perspective view taken along line F-F in FIG. 13.

FIG. 16 is a cross-sectional view taken along line G-G in FIG. 13.

FIG. 17 is a schematic perspective view showing an optical device according to a fourth exemplary embodiment of the invention.

FIG. 18 is a perspective view taken along line H-H in FIG. 17.

FIGS. 19 and 20 are views showing simulation results of light paths in an optical device of the related art and those in an optical device of the invention.

FIG. 21 is a schematic view showing a part of an LCD including an optical device according to an exemplary embodiment of the invention.

### BEST MODE

The present invention will now be described more fully hereinafter with reference to the accompanying drawings, in which exemplary embodiments thereof are shown. The technical concept of the invention associated with an optical device according to an exemplary embodiment of the invention can be widely applied to any structure which is generally used in a Liquid Crystal Display (LCD). Therefore, the optical device, which will be described hereinafter, is provided for the purpose of illustration as a basic structure of a device that is used in the LCD.

Furthermore, in the following description of the present invention, detailed descriptions of known functions and components incorporated herein will be omitted when they may make the subject matter of the present invention rather unclear.

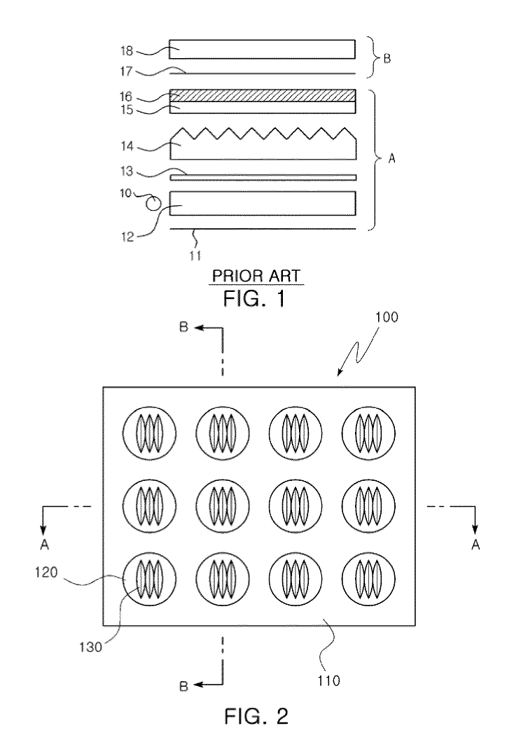

FIG. 2 is a plan view showing an optical device according to a first exemplary embodiment of the invention.

Referring to FIG. 2, the optical device 100 according to the first exemplary embodiment of the invention includes a light-transmitting base film 110; a plurality of convex portions 120, which are formed on at least one surface of the base film 110; and first microscopic optical patterns 130, each of which is formed on part of a corresponding convex portion 120, such that multiple peaks 131 and valleys 132, which abut each other.

The base film 110 of the invention is made of a light-transmitting material that is one selected from among, for example, Polycarbonate (PC), Polyester (PET), Polyethylene (PE), Polypropylene (PP), and Polymethyl Methacrylate (PMMA).

On at least one surface of the base film 110, the multiple convex portions 120 are formed. The convex portions 120 are formed regularly or irregularly across the entire or partial area of one surface of the base film 110 in order to prevent Newton rings or wet-out from occurring. As shown in FIG. 2, the convex portions can have a variety of shapes, such as those of a circle, ellipse, rectangle, triangle, and diamond, when projected on the plane of the base film 110. The convex portions 120 act to diffuse light that has entered the base film 110, thereby imparting a wide viewing angle.

On part of each convex portion 120, each first microscopic optical pattern 130 is formed such that multiple peaks 131 and valleys 132 abut each other. In particular, it is preferred that the first microscopic optical pattern 130 be formed on the central portion of the convex portion 120. The first microscopic optical pattern 130 serves to condense and emit light that has entered the base film 110, so that the light is directed substantially vertical to a liquid crystal panel (not shown), which is above the first microscopic optical pattern 130.

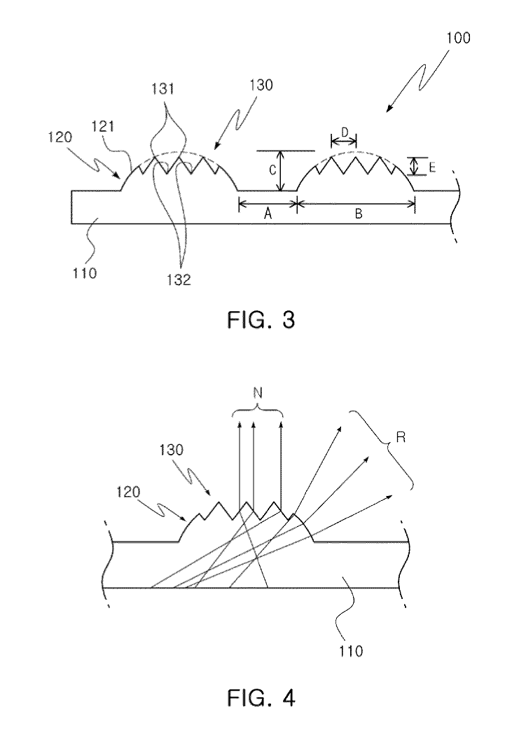

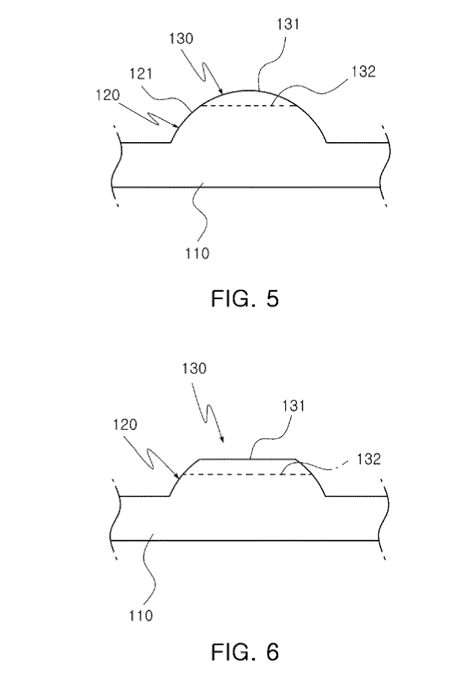

FIG. 3 is a cross-sectional view taken along line A-A in FIG. 2, FIG. 4 is an enlarged view of the key part in FIG. 3, FIG. 5 is a cross-sectional view taken along line B-B in FIG. 2, and FIG. 6 is a cross-sectional view showing another embodiment of the first microscopic optical pattern of the invention.

Referring to FIG. 3, the convex portion 120 of the optical device 100 according to the first exemplary embodiment of the invention has a protruding shape with a predetermined curvature. It is preferred that the convex portion 120 have, for example, a hemispherical shape that protrudes from the base film 110. In other words, it is preferred that the convex portion 120 have a semicircular or semielliptical shape when projected from the side of the base film 110 (see FIG. 3). The first microscopic optical pattern 130, including the peaks 131 and the valleys, which abut each other, is formed on part of the convex portion 120 and, preferably, on the central portion of the convex portion 120. Therefore, a side portion 121 shown in FIG. 3, i.e. the portion on which the first microscopic optical pattern 130 is not formed, maintains its original shape, which is curved at a predetermined curvature. As shown in FIG. 4, incident light that is incident from below is emitted vertically upward (in the N direction) by being condensed by the first microscopic optical pattern 120, and is emitted (in the R direction) by being diffused by the side portion 121 of the convex portion 120, thereby increasing the luminance of the LCD at oblique angles. Thereby, this structure can realize a satisfactory viewing angle and has a double function as a diffuser film in the backlight unit.

As shown in FIG. 3, it is preferred that the distance A between the convex portions 120 range from 50 to 150 μm, and that the diameter B of the convex portions 120 range from 50 to 100 μm. Here, the convex portions 120 can be formed as a figure that has long and short axes when projected on the plane of the base film 110. It is preferred that the length of the long axis range from 50 to 100 μm, and that the length of the short axis range from 1 to 100 μm. In the case in which each convex portion 120 is in the form of an ellipse, a rectangle, or a diamond, it is preferred that the length of the long axis, the short axis, or a diagonal range from 50 to 100 μm. In addition, it is preferred that the height C of the convex portion 120 range from 10 to 40 μm. At least some of the multiple convex portions 120 can have different sizes. Here, it is preferred that the shape of the convex portions 120, including the size, height, interval, and the like, be determined in consideration of their overall density and luminance as well as the ease of manufacture. For example, if the convex portions 120 have a diameter or height that is less than 50 μm, it is difficult to form the first microscopic optical pattern 130 on the upper area thereof. Conversely, if the diameter or height exceeds 100 μm, the overall luminance is lowered. Meanwhile, if the interval between the convex portions 120 is less than 50 μm, luminance characteristics at oblique angles are not improved, whereas if the interval exceeds 150 μm, density decreases, thereby lowering the luminance characteristics. However, the convex portions 120 and the first microscopic optical pattern 130 as above are only an exemplary embodiment, and can, of course, be designed differently by varying the dimensions thereof depending on the luminance and the manufacturing characteristics of a product to be realized.

Furthermore, it is preferred that the width D of the peaks 131 of the first microscopic optical pattern 130 range from 10 to 30 μm, and that the height E of the peaks 131 range from 5 to 30 μm. Here, it is preferred that the height of the peaks 131 of the first microscopic optical pattern 130 be smaller than the height of the convex portions 120. In addition, the first microscopic optical patterns 130 can have different numbers of peaks and valleys.

In addition, a different microscopic optical pattern (not shown) can be formed on each peak. Like the first microscopic optical pattern 130 as above, peaks and valleys are continuously and repeatedly formed to maximize the efficiency of condensing light that is incident on the base film 110.

Referring to FIG. 5, in the optical device according to the first embodiment of the invention, each peak 131 of the first microscopic optical pattern 13, which is formed on a portion of each convex portion 120, can be curved at a predetermined curvature to form the arc shown in FIG. 5. That is, the peak 131 of the first microscopic optical pattern 130 can be formed such that its height decreases from the center to both ends thereof. However, the present invention is not limited thereto. In the variation shown in FIG. 5, the peak 132 of the first microscopic optical pattern 130 can have a constant height. In other words, as shown in FIGS. 3 and 5, the substantially triangular figures can be continuously arranged in one direction. Here, it is preferred that the peaks 131 of the first microscopic optical pattern 130 be formed such that they do not extend beyond the periphery of the arc, as shown in FIG. 5.

Meanwhile, the optical device 100 according to the first embodiment of the invention can be used in the backlight unit and the LCD. In this case, it is preferred that multiple convex portions 120 be formed on the upper surface of the base film 110. Thus, when light that is generated from a lower-side light source (not shown) enters the multiple convex portions 120 and the first microscopic optical patterns 130 through the base film 110, the multiple convex portions 120 cause luminance to be uniform across the screen of the LCD by diffusing incident light, and the first microscopic optical patterns 130 increase the luminance and the viewing angle of the screen by condensing incident light and emitting it substantially in the vertical direction. Thereby, the invention can realize a wide viewing angle of the screen while maintaining luminance to the greatest extent in the LCD. Here, it is possible to suitably adjust, for example, the size, the density, and the curvature of peaks of the first microscopic optical pattern 130 in consideration of the luminance characteristics of the LCD to the front and at oblique angles.

Embodiments of the invention are not limited to the above-described structure, but the multiple convex portions 120 and the first microscopic optical patterns 130 can be formed on both the upper surface and the underside surface of the base film 110. In this case, light, condensed and diffused by the first microscopic optical patterns 130 on the underside surface, passes through the base film 110, and is then condensed and diffused again by the convex portions 120 and the first microscopic optical patterns 130, which are on the upper surface. As above, when the optical device 100 according to the first exemplary embodiment of the invention is applied to the backlight unit of the LCD, it can have not only the structure shown in the figure, but also a vertically symmetrical structure.

The optical device 100 according to the first exemplary embodiment of the invention can be used as a diffuser plate in the backlight unit of the LCD. When the optical device 100 is used as the diffuser plate, the base film 110 can be, for example, a PET film.

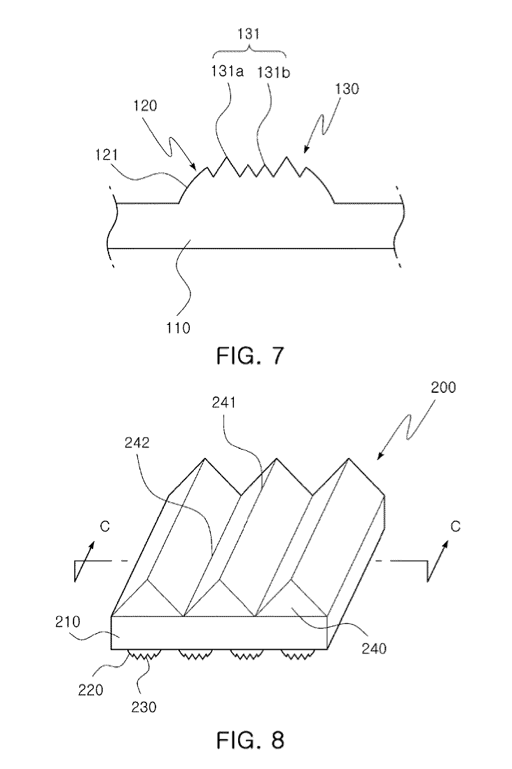

FIG. 7 is an example view showing a variation of the optical device according to the first exemplary embodiment of the invention.

Referring to FIG. 7, in the optical device according to the first exemplary embodiment of the invention, the peaks 131 of each first microscopic optical pattern 130, which is formed on all or part of the area of a corresponding convex portion 120, can include first peaks 131a and second peaks 131b, the height of the second peaks 131b being different from that of the first peaks 131a. In this fashion, by the formation of the first and second peaks 131a and 131b to have different heights, it is possible to increase light-condensing efficiency than the first microscopic optical pattern 130 in which the peaks have the same height and thus efficiently provide light to the LCD.

FIG. 8 is a perspective view showing an optical device according to a second exemplary embodiment of the invention.

Referring to FIG. 8, the optical device 200 according to the second exemplary embodiment of the invention includes a light-transmitting base film 210; a plurality of convex portions 220, which is formed on one surface of the base film 210; first microscopic optical patterns 230, each of which is formed on part of a corresponding convex portion 220, such that multiple peaks 231 and valleys 232, which abut each other; and second microscopic optical patterns 240 formed on the opposite surface of the base film 210, each second microscopic optical patterns 240 including multiple peaks 241 and valleys 242, which abut each other.

The base film 210 of the invention is made of a light-transmitting material that is one selected from among, for example, Polycarbonate (PC), Polyester (PET), Polyethylene (PE), Polypropylene (PP), and Polymethyl Methacrylate (PMMA).

On one surface of the base film 210, the multiple convex portions 220 are formed. The convex portions 220 can have a variety of shapes, such as a circle, ellipse, rectangle, triangle, and diamond, when projected from above. On part of each convex portion 220, each first microscopic optical pattern 230 is formed such that multiple peaks 231 and valleys 232 abut each other. Here, it is preferred that the first microscopic optical pattern 230 be formed on the central portion of the convex portion 220. The convex portions 220 serve to diffuse light that has entered the base film 210, so that the light exits to a liquid crystal panel (not shown), which is above the convex portions 220, and the first microscopic optical pattern 230 serves to condense and emit light that has entered the base film 210, so that light is directed substantially vertical to the liquid crystal panel, which is above the first microscopic optical pattern 230.

The base film 210, the convex portions 220, and the first microscopic optical patterns 230 according to the second exemplary embodiment of the invention have the same configuration and function as those of the base film 110, the convex portions 120, and the first microscopic optical patterns 130 according to the first exemplary embodiment of the invention, which are described with reference to FIGS. 2 to 4. Therefore, repeated descriptions thereof will be omitted.

The second microscopic optical patterns 240 of the invention are formed on the opposite surface of the base film 210 on which no convex portions 220 are formed. In an embodiment of the invention, it is preferred that each of the second microscopic optical patterns 240 be a prism pattern in which multiple peaks 241 and valleys 242 abut each other. For example, the second microscopic optical pattern 240 can be a prism pattern in which substantially triangular figures are continuously arranged in one direction of the base film 210 such that the peaks 241 and the valleys abut each other. Preferably, the second microscopic optical patterns 240 serve to condense and emit light that is incident from below, thereby increasing luminance across the entire viewing surface of a liquid crystal panel (not shown), which is above the second microscopic optical patterns 240. Each prism of the second microscopic optical patterns 240 has a cross section that is selected from among those of a triangle, an arc, and a polygon, when its cross section is projected.

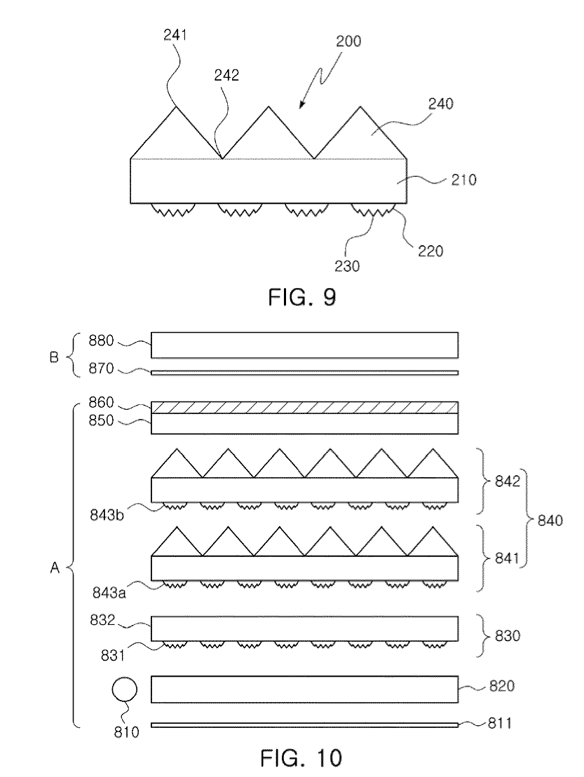

FIG. 9 is a cross-sectional view taken along line C-C in FIG. 8.

Referring to FIG. 9, the first microscopic optical pattern 230 and the second microscopic optical pattern 240 have a cross section chat is, preferably, triangular when their cross sections are projected. In an alternative embodiment of the invention, they can have a cross section, such as an arc or a trapezoid. Since the first microscopic optical pattern 230 is formed on part of the convex portion 220, the remaining portion 221 of the convex portion 220, in which the first microscopic optical pattern 230 is not formed, is preferably curved at a predetermined curvature (to form an arc), and serves to diffuse incident light to the surroundings.

Each peak 231 of the first microscopic optical pattern 230 and each peak 241 of the second microscopic optical pattern 240 are illustrated as being formed to be parallel to each other in the figure. As an alternative, however, the peaks 231 and 241 can be arranged such that they intersect each other at predetermined angles in an intention to prevent a moiré phenomenon. The predetermined angle includes the concept in which the peaks 231 and 241 intersect each other at right angles, and ranges, preferably, from 45 to 90°. It is also preferred that the peaks 231 of the first microscopic optical pattern 230 be vertically arranged in an LCD in order to realize a wide viewing angle by increasing the luminance of the LCD at oblique angles (from the right and left).

The optical device 200 according to the second embodiment of the invention can be applied to a backlight unit and an LCD. In this case, it is preferred that the convex portions 220 and the first microscopic optical pattern 230 be formed on the underside surface of the base film 210 and the second microscopic optical pattern 240 be formed on the upper surface of the base film 210. Thus, when incident light that is generated from a lower-side light source (not shown), enters the convex portions and the first microscopic optical pattern 230 on the underside surface, the convex portions 220 and the first microscopic optical patterns 230 serve to diffuse the incident light so that the incident light exits to the base film 210, and when the incident light enters the second microscopic optical pattern 240 through the base film 210, the first microscopic optical pattern 230 serves to condense the incident light while emitting it upward. Thereby, it is possible to realize a wide viewing angle while maintaining luminance characteristics. Here, it is possible to suitably adjust, for example, the size, the density, and the curvature of peaks of the first microscopic optical pattern 230 in consideration of the luminance characteristics of the LCD to the front and at oblique angles.

Embodiments of the invention are not limited to the above-described structure. Rather, the multiple convex portions 220 and the first microscopic optical patterns 230 can be formed on the upper surface of the base film 210, and the second microscopic optical patterns 240 can be formed on the underside surface of the base film 210. In this case, the second microscopic optical patterns 240 condense incident light that is incident from below, while emitting it to the base film 210, and the convex portions 220 and the first microscopic optical patterns 230 emit the light that has passed through the base film 210 by diffusing and condensing it. Through the diffusion of light as above, it is possible to realize a wide viewing angle at oblique angles.

The optical device 200 according to the second embodiment of the invention can be used as a common prism sheet in a backlight unit of the LCD. In this case, the base film 210 can be formed as a PET film.

FIGS. 10 to 12 are schematic views, each of which shows a part of an LCD including an optical device according to an exemplary embodiment of the invention.

As shown in FIG. 10, the LCD 800 of the invention includes a backlight unit A and a panel unit B. Specifically, the LCD 800 includes a light guide plate 820, a diffuser plate 830, at least one prism sheet 840, a reflective polarizer film 850, a phase retardation layer 860, an absorptive polarizer film 870, and a liquid crystal panel 880. The light guide plate 820 and the diffuser plate 830 diffuse and emit light that is incident from a light source 810 and light that is reflected from a reflector 811. The prism sheet 840 condenses the light that is incident from the diffuser plate 830. The reflective polarizer film 850 selectively reflects the light that is incident from the prism sheet 840. The phase retardation layer 860 converts the circularly-polarized light that has passed through the reflective polarizer film 850 into linearly-polarized light. The absorptive polarizer film 870 allows the linearly-polarized light to pass through, and allows 50% of circularly-polarized light to pass through but absorbs the remaining portion thereof. The liquid crystal panel 880 displays images on a screen.

In the case in which the diffuser plate 830 or the prism sheet 840 is embodied using the optical device according to exemplary embodiments of the invention, multiple convex portions 831, 843a, and 843b, with a microscopic optical pattern formed thereon, are formed on one surface (e.g., the underside surface) of at least one of the diffuser plate 830 and the prism sheet 840 in order to condense and diffuse light. In addition, in an embodiment of the invention, the prism sheet 840 can have a structure in which an upper prism sheet 842 is stacked on a lower prism sheet 841.

As above, the optical device of the invention can be embodied in various forms in the backlight unit. In particular, the optical device can realize a wide viewing angle from the side while maintaining luminance characteristics to the greatest extent by condensing and diffusing incident light using the microscopic optical patterns.

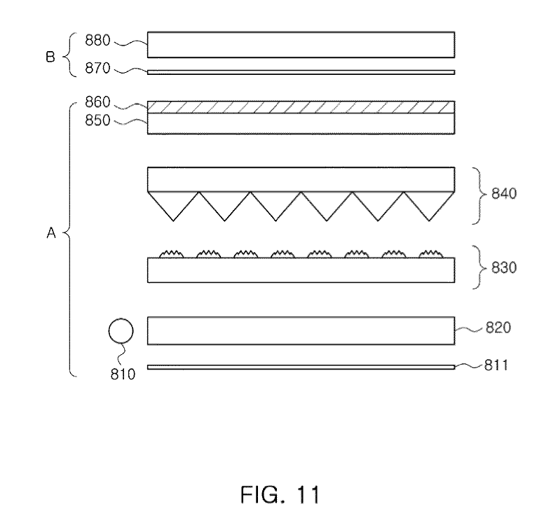

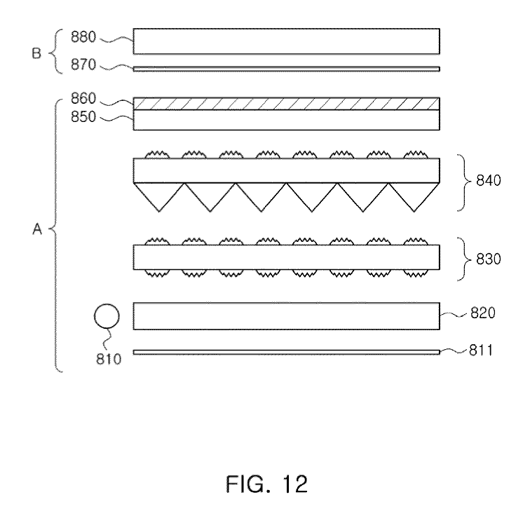

Referring to FIGS. 11 and 12, different examples in which optical devices 830 and 840 according to embodiments of the invention are applied to LCDs are shown.

In FIG. 11, the optical device 830 of the invention, in which multiple convex portions 832, with a microscopic optical pattern formed thereon, are formed on the upper surface of a light-transmitting base film 831, can be used, for example, as a diffuser plate. In addition, in FIG. 11, the optical device 830 of the invention, in which the multiple convex portions 832, with microscopic optical patterns formed thereon, are formed on both surfaces, i.e. the upper and lower surfaces, of the light-transmitting base film 831, can be used as a diffuser plate. Here, the convex portions formed on the upper surface and the convex portions formed on the underside surface of the base film 831 can be arranged such that they intersect each other at predetermined angles. In FIG. 12, the other optical device 840, in which multiple convex portions 842, with a first microscopic optical pattern formed thereon, are formed on the upper surface of a base film 841, and second microscopic optical patterns 843 including peaks and valleys, which abut each other, are formed on the underside surface of the base film 841, can be used as a prism sheet.

As above, in the invention, the optical device can be embodied in various forms in the backlight unit.

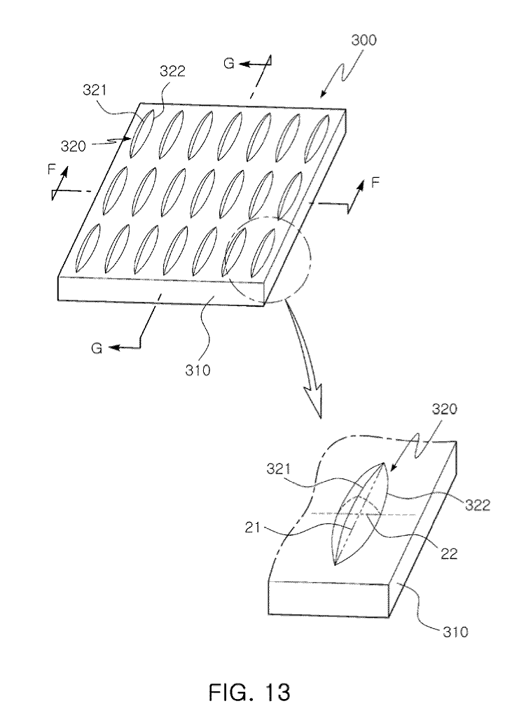

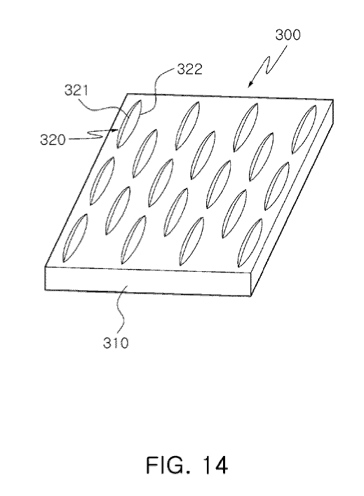

FIGS. 13 and 14 are schematic perspective views each showing an optical device according to a third exemplary embodiment of the invention.

Referring to FIGS. 13 and 14, the optical device 300 according to the third exemplary embodiment of the invention includes a light-transmitting base film 310 and a plurality of third microscopic optical patterns 320, which are formed on at least one surface of the base film 110.

The base film 310 of the invention is made of a light-transmitting material that is one selected from among, for example, Polycarbonate (PC), Polyester (PET), Polyethylene (PE), Polypropylene (PP), and Polymethyl Methacrylate (PMMA).

The third microscopic optical patterns 320 of the invention are formed on at least one surface of the base film 310, such that each of the third microscopic optical patterns 320 has a peak 321 with a predetermined height. The third microscopic optical patterns 320 condense and diffuse light that has entered the base film 310. It is preferred that the third microscopic optical patterns 320 be formed integrally with at least one surface of the base film 310.

In addition, the third microscopic optical pattern 320 of the invention is formed as a figure that has long and short axes, i.e. an ellipse or a leaf, when projected on a plane from above. In other words, each of the third microscopic optical patterns 320 of the invention has an elliptical shape 322 in the portion thereof, which abuts at least one surface of the base film 310. Here, each peak 321 of the third microscopic optical patterns 320 has a height that decreases from the center to both ends along the long axis of the elliptical shape 322. It is more preferred that the peak 321 of the third microscopic optical pattern be curved at a predetermined curvature along the longer axis of the elliptical shape 322.

In an embodiment of the invention, it is preferred that the length of the long axis range from 1 to 5000 μm, and that the length of the short axis range from 1 to 100 μm. In the elliptical shape, the ratio of the length of the short axis to that of the long axis exceeds 1:1 and is, preferably, the same as or less than 1:50000. In addition, it is preferred that the interval between the third microscopic optical patterns range from 1 to 5000 μm. In an embodiment of the invention, the ratio of the length of the short axis to that of the long axis, the interval between the third microscopic optical patterns, the height of the peaks, the repetition and distribution of the patterns, and the like can be determined by the efficiency of condensing and diffusing incident light. Furthermore, they can be determined by the luminance of an LCD at oblique angles.

Meanwhile, the multiple third microscopic optical patterns of the invention can be arranged at predetermined intervals. In an example of the invention, as shown in FIG. 13, the multiple third microscopic optical patterns can be arranged in the form of a matrix, in which the patterns are arranged in columns and rows. In another example, as shown in FIG. 14, the third microscopic optical patterns can be arranged in a staggered configuration.

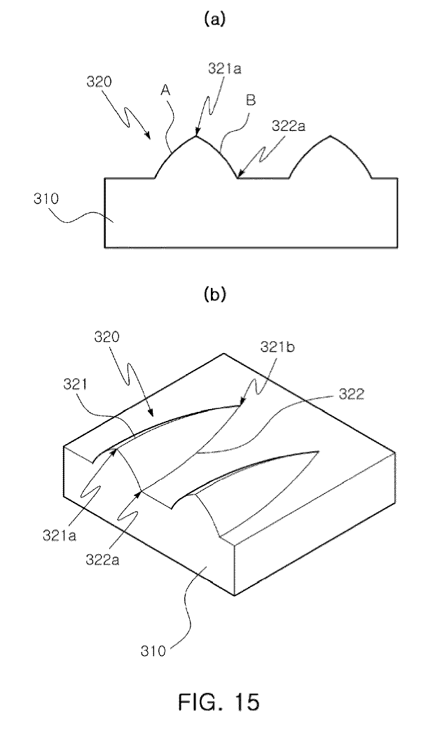

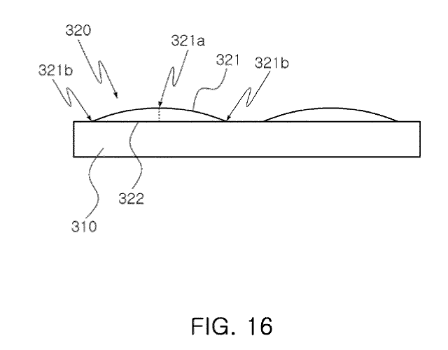

FIG. 15 is a cross-sectional view and a perspective view taken along line F-F in FIG. 13, and FIG. 16 is a cross-sectional view taken along line G-G in FIG. 13.

Referring to FIG. 15, the third microscopic optical pattern according to the third exemplary embodiment of the invention has a triangular cross section, which protrudes substantially from the upper surface of the base film 310, when taken along the short axis. The center 321a of the triangular shape is part of the peak 321 of the third microscopic optical pattern. Here, it is preferred that edge lines A and B, which extend from the center 321a to the surface 322a of the base film 310 along the short axis 22 of the elliptical shape 322, be curves. This is because incident light is not only condensed but also diffused to the side when the edge lines A and B are curves. However, the invention is not limited thereto, but can be embodied in straight lines. In this case, the condensing of incident light is more influential than the diffusion of incident light. Thereby, the third microscopic optical pattern can realize not only the function of condensing incident light but also the function of diffusing it to the side. In addition, the peak 321 of the third microscopic optical pattern has a predetermined height along the long axis of the elliptical shape 322. The height of the peak 321 varies, preferably, along the long axis 21 of the elliptical shape 322. This is illustrates in detail in FIG. 16. Although the cross section of the third microscopic optical pattern is shown as having a triangular shape in the figure, the invention is not limited thereto, but can be embodied in various forms, such as these of a regular triangle, an equilateral triangle, an arc, a trapezoid, and a quadrangle. In addition, it is preferred that the peak 321 of the third microscopic optical pattern be oriented vertically in order to realize a wide viewing angle by increasing the luminance of an LCD at oblique angles.

Referring to FIG. 16, in the third microscopic optical pattern according to the third exemplary embodiment of the invention, the height of the peak 321 of the third microscopic optical pattern decreases from the center 321a to both ends 321b along the long axis 21 of the elliptical shape 322, which abuts at least one surface of the base film 310. In other words, the peak 321 of the third microscopic optical pattern is highest at the center 321 but its height decreases in the direction toward the both ends 321b. In particular, it is preferred that the peak 321 of the third microscopic optical pattern be curved at a predetermined curvature along the long axis 21 of the elliptical shape 322. Here, the height of the peak 321 at the center 321a ranges, preferably, from 0.2 to 200 μm. If the height of the peak 321 is greater or less than this range, processing becomes complicated and the light-condensing efficiency is lowered beyond that range. Thus, the height beyond this range does not exhibit an available result.

Although FIG. 16 illustrates, in an exemplary embodiment of the invention, that the peak 321 is curved at a predetermined curvature when viewed from an edge of the third microscopic optical pattern, the present invention is not limited to this structure. In another example, the peak can be curved at different curvatures or extend along a straight line from the center 321a to the both ends 321b. However, for application to an LCD, the peak 321 extending from the center 321a to the both ends 321b along the long axis 21 is, preferably, symmetrical and, more preferably, curved at a predetermined curvature in order to provide uniform luminance across the entire viewing surface.

The optical device 300 according to the third exemplary embodiment of the invention is applicable to a backlight unit and an LCD. In this case, it is preferred that the third microscopic optical pattern be formed on the upper surface of the base film 310. Thus, when light that is generated from a lower-side light source (not shown) enters the third microscopic optical patterns through the base film 110, the third microscopic optical patterns condense the incident light while diffusing it to the side at the same time. Thereby, the invention can realize a wide viewing angle while maintaining luminance characteristics. Here, it is possible to suitably adjust, for example, the size, the density, and the curvature of peaks of the third microscopic optical patterns in consideration of the luminance characteristics of the LCD to the front and at oblique angles.

Embodiments of the invention are not limited to the above-described structure, but the third microscopic optical patterns can be formed on both the upper surface and the underside surface of the base film 310. In this case, light, condensed and diffused by the third microscopic optical patterns on the underside surface, passes through the base film 310, and is then condensed and diffused again by the third microscopic optical patterns on the upper surface. As above, when the optical device 300 according to the third exemplary embodiment of the invention is applied to the backlight unit of the LCD, it can have not only the structure shown in the figure, but also a vertically symmetrical structure.

The optical device 300 according to the third exemplary embodiment of the invention can be used as a diffuser plate in the backlight unit of the LCD. When the optical device 300 is used as the diffuser plate, the base film 310 can be, for example, a PET film.

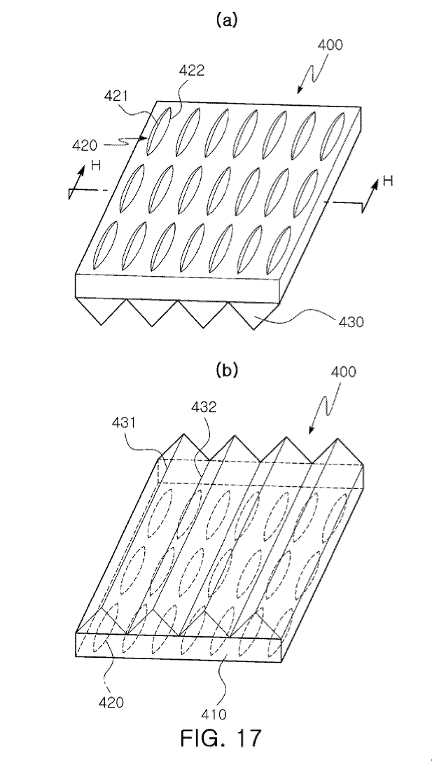

FIG. 17 is a schematic perspective view showing an optical device according to a fourth exemplary embodiment of the invention.

Referring to FIG. 17, the optical device according to the fourth exemplary embodiment of the invention a light-transmitting base film 410, third microscopic optical patterns 420, which are formed on one surface of the base film 410, and fourth microscopic optical patterns 430, which are formed on the opposite surface of the base film 410.

The base film 410 of the invention is made of a light-transmitting material that is one selected from among, for example, Polycarbonate (PC), Polyester (PET), Polyethylene (PE), Polypropylene (PP), and Polymethyl Methacrylate (PMMA).

The third microscopic optical patterns 320 of the invention are formed on one surface of the base film 410, such that each of the third microscopic optical patterns 320 has a peak 421 with a predetermined height. The third microscopic optical patterns 420 condense and diffuse light that has entered the base film 410. It is preferred that the third microscopic optical patterns 420 be formed integrally with one surface of the base film 410.

The base film 410 and the third microscopic optical patterns 420 according to the fourth exemplary embodiment of the invention have the same configuration and function as those of the base film 310 and the third microscopic optical patterns according to the third exemplary embodiment of the invention, which are described with reference to FIGS. 2 to 16. Therefore, repeated descriptions thereof will be omitted.

The fourth microscopic optical patterns 440 of the invention are formed on the surface of the base film 410, which is opposite the surface on which third microscopic optical patterns 420 are formed. In an example of the invention, it is preferred that the fourth microscopic optical patterns 440 be prism patterns in which multiple peaks 441 and valleys 442 abut each other. For example, the fourth microscopic optical patterns 440 can be prism patterns in which substantially triangular figures are continuously arranged in one direction of the base film 410 such that the peaks 441 and the valleys abut each other. Preferably, the fourth microscopic optical patterns 440 serve to emit light upward that is incident from below. This, as a result, increases luminance across the entire viewing surface of a liquid crystal panel (not shown), which is above the second microscopic optical pattern 440. Each prism of the fourth microscopic optical patterns 440 has a cross section that is selected from among a triangle, an arc, and a polygon, when the cross section is projected.

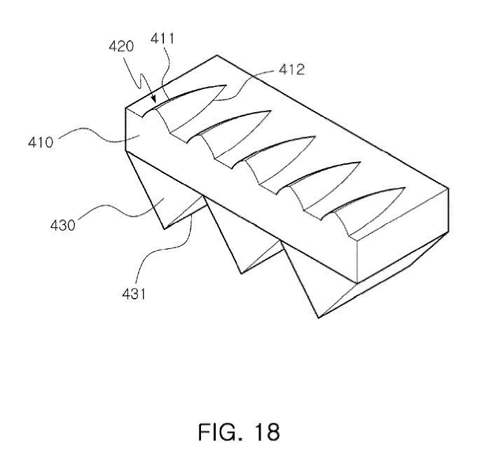

FIG. 18 is a perspective view taken along line H-H in FIG. 17.

Referring to FIG. 18, the third microscopic optical patterns 420 and the fourth microscopic optical patterns 430 have a substantially triangular cross section when their cross sections are projected. Here, in the triangular cross section of the third microscopic optical patterns 420, it is preferred that edge lines A and B, which extend from a peak 411 to an elliptical shape 422, be curves. In the triangular cross section of the fourth microscopic optical patterns 430, it is preferred that lines, which extend from a peak 431 to valleys 432, be straight lines. Although the peaks 421 of the third microscopic optical patterns 420 and the peaks 431 of the fourth microscopic optical patterns 430 are shown, by way of example, as being parallel to each other in the figure, the peaks 421 and 431 can be formed to intersect each other by way of another example. It is also preferred that the peaks 431 of the third microscopic optical patterns 430 be vertically arranged in an LCD in order to realize a wide viewing angle by increasing luminance of the LCD at oblique angles (to the right and left).

The optical device 400 according to the fourth embodiment of the invention can be applied to a backlight unit and an LCD. In this case, it is preferred that the third microscopic optical patterns 430 be formed on the underside surface of the base film 410 and the fourth microscopic optical patterns 440 be formed on the upper surface of the base film 410. Thus, when incident light that is generated from a lower-side light source (not shown) enters the third microscopic optical patterns 430 on the underside surface, it is emitted to base film 410 by being condensed and diffused. Afterwards, when the incident light enters the fourth microscopic optical patterns 440 through the base film 410, it is emitted upward by being condensed. Thereby, it is possible to realize a wide viewing angle while maintaining luminance characteristics. Here, it is possible to suitably adjust, for example, the size, the density, and the curvature of peaks of the third microscopic optical pattern 430 in consideration of the luminance characteristics of the LCD from the front and at oblique angles.

Embodiments of the invention are not limited to the above-described structure. Rather, the third microscopic optical patterns 430 can be formed on the upper surface of the base film 410, and the fourth microscopic optical patterns 440 can be formed on the underside surface of the base film 410. In this case, the fourth microscopic optical patterns 440 condense incident light that is incident from below while emitting it to the base film 410, and the third microscopic optical patterns 430 diffuse and condense the light that has passed through the base film 410. Through the diffusion of the light as above, it is possible to realize a wide viewing angle at oblique angles.

The optical device 400 according to the fourth embodiment of the invention can be used as a common prism sheet in a backlight unit of the LCD. In this case, the base film 410 can be formed as a PET film.

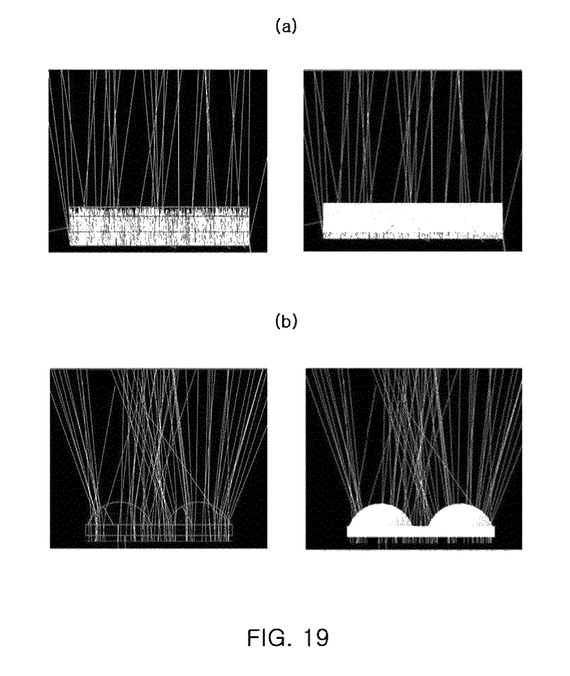

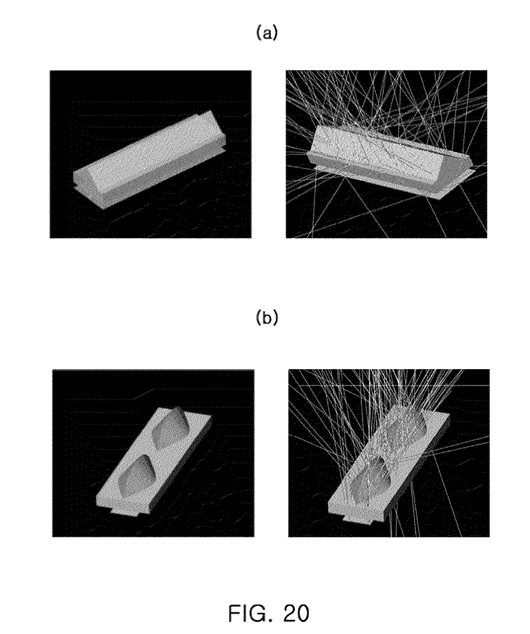

FIGS. 19 and 20 are views showing simulation results, which are produced in order to compare paths of light emitted from an optical device of the related art with those emitted from an optical device of the invention.

FIG. 19 (a) is the simulation result that shows the paths of light at a side area of the optical device of the related art, and FIG. 19 (b) is the simulation result that shows the paths of light at a side area of the optical device according to an embodiment of the invention. As shown in the figures, in the optical device of the related art, the cross section of the side area is defined by straight lines, and thus has substantially no light-diffusing power or light-condensing power. In the optical device of the invention, the cross section of the side area is in the form of a lens, i.e. is curved at a predetermined curvature, and thus generates light-diffusing power and light-condensing power.

In addition, FIG. 20 (a) is the simulation result that shows the paths of light emitted from the optical device of the related art, which is shown in perspective views, and FIG. 20 (b) is the simulation result that shows the paths of light emitted from the optical device according to an embodiment of the invention, which is shown in perspective views. As shown in the figures, the triangular prism of the optical device of the related art generates only light-condensing power, but the optical device of the invention generates not only light-condensing power, but also light-diffusing power toward the side.

Based on the simulation results as above, it can be understood that the optical device of the invention realizes not only the function of condensing light upward but also the function of diffusing light to the side, thereby achieving a wide angle in an LCD.

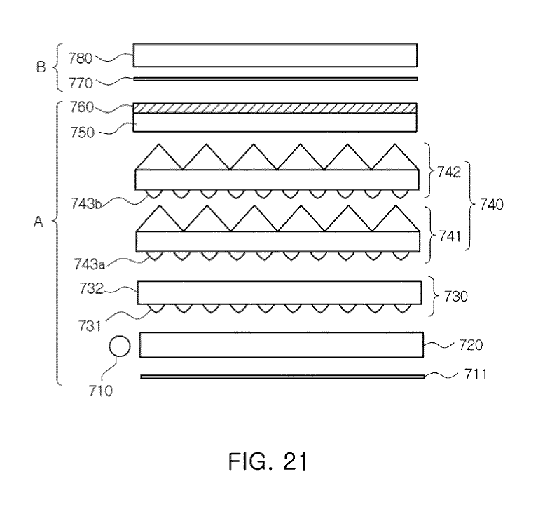

FIG. 21 is a schematic view showing a part of an LCD including an optical device according to an exemplary embodiment of the invention.

As shown in FIG. 21, the LCD 700, of the invention includes a backlight unit A and a panel unit B. Specifically, the LCD 700 includes a light guide plate 720, a diffuser plate 730, at least one prism sheet 740, a reflective polarizer film 750, a phase retardation layer 760, an absorptive polarizer film 770, and a liquid crystal panel 780. The light guide plate 720 and the diffuser plate 730 diffuse and emit light that is incident from a light source 710, and light that is reflected from a reflector 711. The prism sheet 740 condenses the light that is incident from the diffuser plate 730. The reflective polarizer film 750 selectively reflects the light that is incident from the prism sheet 740. The phase retardation layer 760 converts the circularly-polarized light that has passed through the reflective polarizer film 750 into linearly-polarized light. The absorptive polarizer film 770 allows the linearly-polarized light to pass through, and allows 50% of the circularly-polarized light to pass through but absorbs the remaining portion thereof. The liquid crystal panel 780 displays images on a screen.

When the diffuser plate 730 or the prism sheet 740 is realized using the optical device according to any of the embodiments of the invention, multiple microscopic optical patterns 731, 743a, and 743b are formed on one surface (e.g., the underside surface) of at least one of the diffuser plate 730 and the prism sheet 740 such that the patterns condense and diffuse light. In an embodiment of the invention, the prism sheet 740 can have a structure in which an upper prism sheet 742 is stacked over a lower prism sheet 741.

FIG. 21 shows an example of the LCD, and the diffuser plate 730 and the prism sheet 740 can be variously embodied in other embodiments of the invention. For example, the diffuser plate 730 and the prism sheet 740 shown in FIG. 21 can be configured to condense and diffuse light using the multiple microscopic optical patterns 731, 743a, and 743b, which are on the upper surface or the both surfaces of the base film.

According to the invention as set forth above, the optical device can be embodied in various forms in the backlight unit. In particular, it is possible to impart a wide viewing angle while maintaining luminance characteristics to the greatest extent by condensing and diffusing incident light using the microscopic optical patterns.

The foregoing figures and the descriptions of the present invention have been presented by way of example for the purposes of illustration. They are not intended to be exhaustive or to limit the scope of the invention, which is described in the claims. It should be understood that various modifications and equivalents will be apparent to a person having ordinary skill in the art. Therefore, the true scope of protection of the invention shall be defined by the concept of the claims appended hereto.

### INDUSTRIAL APPLICABILITY

Recently, the use of the LCD is gradually increasing in display devices, such as in mobile phones, TVs, navigation devices, and a variety of monitors, and this tendency is expected to continue in the future. In particular, as the size of the display device is increasing, not only the luminance to the front but also the luminance at oblique angles is becoming an important factor. Therefore, the development of technology that imparts a wide viewing angle to the optical device is actively underway.

In such an aspect, the optical device of the invention, which is used in the LCD, can ultimately contribute to the improvement in the quality of a product, since it can improve the light-condensing function and realize a wide viewing angle at a low cost while maintaining high-luminance characteristics. For these reasons, it is expected that the optical device of the invention can be widely used in display devices in the future.

1. An optical device comprising:
a light-transmitting base film;
a plurality of convex portions formed on at least one surface of the base film to diffuse incident light; and
first microscopic optical patterns, wherein each of the first microscopic optical patterns is formed on a corresponding one of the convex portions to condense and emit incident light.

2. The optical device according to claim 1, wherein each of the first microscopic optical patterns has peaks and valleys, which are formed on at least part of the convex portion while abutting each other.

3. The optical device according to claim 1, further comprising a second microscopic optical pattern, wherein the second microscopic optical pattern is formed on an opposite surface of the base film to condense and/or diffuse incident light.

4. The optical device according to claim 3, wherein the second microscopic pattern has peaks and valleys, which abut each other.

5. The optical device according to claim 4, wherein each of the first and second microscopic patterns has peaks and valleys, which are arranged to be parallel to each other.

6. The optical device according to claim 4, wherein each of the first and second microscopic patterns has peaks and valleys, which are arranged to intersect each other at predetermined angles.

7. The optical device according to claim 1, wherein each of the convex portions has a diameter ranging from 50 to 100 μm.

8. The optical device according to claim 1, wherein each of the convex portions is a figure that has long and short axes, wherein the long axis has a length ranging from 50 to 100 μm, and the short axis has a length ranging from 1 to 100 μm.

9. The optical device according to claim 1, wherein each of the convex portions has a height ranging from 10 to 40 μm.

10. The optical device according to claim 1, wherein the convex portions are spaced from each other at an interval ranging from 50 to 150 μm.

11. The optical device according to claim 1, wherein at least some of the convex portions have different heights.

12. The optical device according to claim 1, wherein the first microscopic patterns have a peak height ranging from 5 to 30 μm.

13. The optical device according to claim 1, wherein the first microscopic patterns have a peak width ranging from 10 to 30 μm.

14. The optical device according to claim 1, wherein the first microscopic patterns have different peak heights.

15. The optical device according to claim 1, wherein each of the first microscopic patterns is formed in a central portion of a corresponding one of the convex portions.

16. The optical device according to claim 1, wherein part of the convex portions, on which the first microscopic patterns are not formed, has a shape that is curved at a predetermine curvature.

17. A backlight unit including the optical device described in claim 1.

18. A liquid crystal display including the backlight unit described in claim 17.

19. An optical device comprising:
a light-transmitting base film; and
a plurality of third microscopic optical patterns formed on at least one surface of the base film to condense and emit incident light,
wherein each of the third microscopic optical patterns abuts the base film at a portion thereof, which forms a figure that has long and short axes, wherein each of the third microscopic optical patterns has a peak height that decreases from a central portion to both ends along the long axis.

20. The optical device according to claim 19, wherein the third microscopic optical patterns are formed on one surface of the base film,
the optical device further comprising:
fourth microscopic optical patterns formed on an opposite surface of the base film to condense and/or diffuse the incident light.

21. The optical device according to claim 20, wherein the fourth microscopic optical patterns have peaks and valleys, which abut each other.

22. The optical device according to claim 21, wherein the third and fourth microscopic optical patterns are arranged such that peaks and valleys thereof intersect at predetermined angles.

23. The optical device according to claim 19, wherein the third microscopic optical patterns have peaks, which are curved at a predetermined curvature along the long axis of the elliptical figure.

24. The optical device according to claim 19, wherein the third microscopic optical patterns have peaks, each of which has a central height that ranges from 0.2 to 200 μm.

25. The optical device according to claim 19, wherein, in the figure that forms each of the third microscopic optical patterns, the long axis has a length ranging from 1 to 5000 μm, and the short axis has a length ranging from 1 to 100 μm.

26. The optical device according to claim 19, wherein the third microscopic optical patterns are spaced apart from each other at an interval ranging from 1 to 5000 μm.

27. The optical device according to claim 19, wherein the third microscopic optical patterns are arranged in a form of a matrix a matrix.

28. The optical device according to claim 19, wherein the third microscopic optical patterns are arranged in a staggered configuration.

29. A backlight unit comprising the optical device described in claim 19.

30. A liquid crystal device comprising the backlight unit described in claim 29.
